(19) United States
(12) Patent Application Publication
(10) Pub. No.: US 2022/0297376 A1
(43) Pub. Date: Sep. 22, 2022

(54) ADDITIVE MANUFACTURING PROCESS FOR MAKING A THREE-DIMENSIONAL OBJECT USING SELECTIVE LASER SINTERING

(71) Applicant: SOLVAY SPECIALTY POLYMERS USA, LLC, Alpharetta, GA (US)

(72) Inventors: Christopher WARD, Sandy Springs, GA (US); Stéphane JEOL, Saint-Genis-Laval (FR); Ryan HAMMONDS, Atlanta, GA (US); Emmanuel DAVID, Sandy Springs, GA (US)

(21) Appl. No.: 17/633,976

(22) PCT Filed: Jul. 31, 2020
(86) PCT No.: PCT/EP2020/071641

§ 371 Date: Feb. 9, 2022

Related U.S. Application Data
(60) Provisional application No. 62/886,784, filed on Aug. 14, 2019.

(30) Foreign Application Priority Data
Oct. 9, 2019 (EP) 19202245.7

(51) Int. Cl. B29C 64/268; B33Y 10/00; B29C 64/153; B29C 64/314

(52) U.S. Cl. CPC B29C 64/268; B33Y 10/00; B29C 64/153; B29C 64/314; B29K 2105/26

(57) ABSTRACT

The present disclosure relates to an additive manufacturing (AM) process for making a three-dimensional (3D) object, using a powdered polymer material (M) comprising at least one semi-crystalline polymer or copolymer (P), in particular to a 3D object obtainable by laser sintering from this powdered polymer material (M).

### TECHNICAL FIELD

The present disclosure relates to an additive manufacturing (AM) process for making a three-dimensional (3D) object, using a powdered polymer material (M) comprising at least one semi-crystalline polymer or copolymer (P), in particular to a 3D object obtainable by laser sintering from this powdered polymer material (M).

### BACKGROUND

Additive manufacturing systems are used to print or otherwise build 3D objects from a digital blueprint created with computer-aided design (CAD) modelling software. Selective laser sintering (“SLS”), one of the available additive manufacturing techniques, uses electromagnetic radiation from a laser to fuse powdered materials into a mass. The laser selectively fuses the powdered material by scanning cross-sections generated from the digital blueprint of the object on the surface of a powder bed. After a cross-section is scanned, the powder bed is lowered by one layer thickness, a new layer of material is applied, and the bed is rescanned. Locally full coalescence of polymer particles in the top powder layer is necessary as well as an adhesion with previous sintered layers. This process is repeated until the object is completed.

A SLS printer generally includes a printing chamber wherein the selective laser sintering of the powder actually takes place. The printing chamber generally includes a part bed and heating elements, in order to control the temperature of the part bed. During the process, layers of the powder are successively applied on the part bed or on the powder previously disposed on the part bed, and then sintered until the 3D object is completed. For semi-crystalline polymers, crystallization should be inhibited during printing as long as possible, at least for several sintered layers. The processing temperature must therefore be precisely adjusted between the melting temperature (Tm) and the crystallization temperature (Tc) of the semi crystalline polymer, also called the “sintering window”. The laser causes fusion of the powder only in locations specified by the input. Laser energy exposure is typically selected based on the polymer in use and to avoid polymer degradation.

When the process is completed, the non-fused powder is removed from the 3D object and can be recycled and reused in a subsequent SLS process.

Producing an article by laser sintering can take a long time, frequently more than 16 hours, even for small articles. This means that the powder material is submitted to high temperatures in the SLS printer for an extended period of time (called thermal aging). This can irreversibly affect the polymer material, in such a way that it is not recyclable anymore. Not only the chemical nature of the polymer is changed due to thermal aging, but also its mechanical properties of the polymer material such as its toughness. For some semi crystalline polymers, such as poly(ether ether ketone) (PEEK), poly(ether ketone ketone) (PEKK) or polyphenylene sulphide (PPS) or high melting temperature polyamide (PA), the processing temperature is too high, causing degradation and/or crosslinking, which negatively affect SLS processability and powder recycling. The potential of the SLS process is therefore limited by the restricted number of materials optimised for the process.

WO 2012/160344 A1 (Airbus) relates to an additive layer manufacturing method for producing a shaped article from polymer material consisting in producing a support structure and then forming the article upon the support structure. The processing temperature varies between the glass transition temperature and the re-solidification temperature of the polymer. The lower the processing temperature the higher the power of the energy source for sintering, and vice versa. At temperatures close to the glass transition temperature, the article requires significantly more support structures to prevent distortion caused by the accumulation of thermal residual stresses generated during the solidification process. Conversely, processing at the upper end of the temperature range, with lower beam energy, requires little support structures in the build. However, the higher powered energy source consumes more energy.

WO 2019/053239 A1 (Solvay) relates to a laser sintering process based on the use of powdered material made of a blend of polymers comprising at least a semi-crystalline PEEK polymer and at least one amorphous PAES polymer, which allows to significantly reduce the degrading and/or crosslinking of the powdered material, thereby allowing unsintered material to be recycled and used in the manufacture of a new 3D object.

The laser sintering 3D printing process of the present invention is based on the adjustment of temperatures used to process the powder material into a 3D object and then keep it until the 3D object is completed. The process is also based on the selection of a polymeric powdered material comprising at least a semi-crystalline polymer having specific thermal transition temperatures, namely melting temperature, glass transition temperature and crystallisation temperature. The combination of both the process temperatures and polymer thermal transitions temperatures allows the manufacture of good 3D objects via SLS, without significantly degrading and/or crosslinking the powdered material, thereby allowing unsintered material to be recycled and used in the manufacture of a new 3D object. The 3D objects obtained from the additive manufacturing process of the invention advantageously present mechanical properties (e.g. tensile strength) similar to the previously described processes.

### SUMMARY

The present invention relates to an additive manufacturing process for making a three-dimensional (3D) object. The process comprises the steps of:
a) applying successive layers of a powdered polymer material (M) onto a part bed of a SLS printer, the material (M) having a d₅₀-value ranging from 20 to 100 μm, as measured by laser scattering in isopropanol, and comprising at least one semi-crystalline polymer or copolymer (P),
b) heating the layer of powdered polymer material (M) to be printed at a processing temperature (Tp), and selectively sintering each layer prior to deposition of the subsequent layer,
c) keeping the printed part and unsintered material (M) at a part bed temperature (Tb) until the 3D object is completed, wherein the process and material (M) are such that at least inequalities (1) to (4) are met:

Tm≥230° C. (1)

Tb<Tp (2)

Tm−40° C.<Tp<Tm (3)

Tg<Tb<Tm−40° C. (4)

wherein Tm (° C.) and Tg (° C.) are respectively the melting temperature and the glass transition temperature of P, as measured by differential scanning calorimetry (DSC) at 20° C./min, according to ASTM D3418.

The process for manufacturing a 3D object of the present invention employs a powdered polymer material (M) comprising a semi-crystalline polymer as the main element of the polymer material. The powdered polymer material (M) can have a regular shape such as a spherical shape, or a complex shape obtained by grinding/milling of pellets or coarse powder.

The powdered polymer material (M) used in the process of the invention has a d₅₀-value ranging from 20 to 100 μm, as measured by laser scattering in isopropanol. This material (M) can be prepared by milling or grinding the components of the material (M), and optionally cooled down to a temperature below 25° C. before and/or during grinding.

The 3D objects or articles obtainable by such process of manufacture have expected mechanical properties and can be used in a variety of final applications. Mention can be made in particular of implantable device, medical device, dental prostheses, brackets and complex shaped parts in the aerospace industry and under-the-hood parts in the automotive industry.

### DISCLOSURE OF THE INVENTION

The powdered polymer material (M) used in the process of the invention is based on a semi-crystalline polymer or copolymer, which can be selected from the group consisting of a poly(aryl ether ketone) (PAEK), a polyphenylene sulfide (PPS), a semi-aromatic, semi-crystalline polyimide (PI), a polyamide (PA) or a polyphthalamide (PPA), a semi-aromatic polyester and an aromatic polyester (PE).

The additive manufacturing process of the present invention, using a powdered polymer material (M) comprising a semi-crystalline polymer (P), is based on the combination of the adjustment of the temperature profile used in the SLS printer and the selection of specific polymer thermal transition temperatures, as part of the material (M). More precisely, the inventors have identified that the adjustment of the processing temperature (Tp) and the part bed temperature (Tb), combined with certain polymer transition temperature ranges, can positively impact the possibility to recycle the unused polymer material (M), without notably compromising the printability and the mechanical properties of the printed object obtained therefrom.

The inventors have identified that at least four inequalities need to be met in order to reach these goals.

According to the first inequality, the polymer (P) of the present invention has a melting temperature (Tm) greater than 230° C., as measured by differential scanning calorimetry (DSC) according to ASTM D3418.

The glass transition and melting temperatures of the polymer described in the present invention are measured using differential scanning calorimetry (DSC) according to ASTM D3418 employing a heating and cooling rate of 20° C./min. Three scans are used for each DSC test: a first heat up to a temperature above polymer's Tm+15° C. (i.e. a temperature at which the polymer does not degrade), followed by a first cool down to 30° C., followed by a second heat up to a temperature above polymer's Tm+15° C. The Tm is determined from the first heat up. The Tg is determined from the second heat up. DSC was performed on a TA Instruments DSC Q20 with nitrogen as the carrier gas (99.998% purity, 50 mL/min).

According to the second inequality, the part bed temperature (Tb), at which the unsintered material (M) is kept in the part bed until the end of the 3D printing process (i.e. until the 3D object is completed), is lower than the processing temperature (Tp), at which each layer of material (M) is sintered at the part bed. The inventors have discovered and shown that setting a part bed temperature lower than the processing temperature is particularly advantageous as it minimize the impact of the high processing temperature on the powdered material (M) and consequently the recyclability of the material (M). The process of the present invention is conducted at a temperature set where the thermal aging of the powdered polymer material (M), which can be assessed by the polymer aspect (for example color), the coalescence ability and the disaggregation ability, is significantly reduced. In other words, the powdered material shows less significant signs of thermal aging, can be recycled and used to prepare a new article by laser sintering 3D printing, as such or in combination with neat powdered polymer material. Also, lowering the part bed temperature (Tb) vis-a-vis the processing temperature helps in reducing the amount of energy spent during the printing process.

During operation of the printer, a roller/blade system or a similar device evenly distributes a layer of material (M) across the surface of the part bed or the material previously deposited on the bed. In some embodiments, a laser and a scanning device disposed above the part bed selectively distributes a laser beam across the layer of material (M) according to a program. After sintering, the part bed is lowered by one polymer layer and a new layer of material (M) is deposited on the previously deposited layer, which seats on the part bed. The part bed is then rescanned and the process is repeated until completion of the 3D object.

The term “part bed temperature” hereby means the temperature at which the part under completion and unsintered material (M) are kept in the part bed of the SLS printer, after sintering and until completion of the 3D object. This temperature is measured by side and bottoms sensors, surrounding and underneath the part under completion and unsintered material (M), in the printing chamber of the SLS printer. This temperature is controlled by heating elements through the printer's software and hardware system.

The term “processing temperature” hereby means the temperature of the most upper layers of powdered material (M) during the printing process. The processing temperature is the temperature at which each layer of material (M) is heated at the upper layers of part bed during the process for manufacturing the 3D object, before being sintered. This temperature is measured by a surface sensor in the SLS printer and controlled by separate heating elements through the printer's software and hardware system.

According to the third inequality, the processing temperature (Tp) is strictly comprised between the melting temperature (Tm) of the polymer (P) −40° C. and Tm.

According to the fourth inequality, the part bed temperature (Tb) is strictly comprised between the glass transition temperature (Tg) of the polymer (P) and the melting temperature (Tm) of the polymer (P) −40° C.

In some embodiments, at least one of the inequalities (1) to (4) is as follows:

Tm≥240° C. (1),

Tm≥250° C. (1),

Tm≥260° C. (1),

Tb<Tp−10° C. (2),

Tm−40° C.<Tp<Tm−5° C. (3)

Tg<Tb<Tm−50° C. (4)

Tm−30° C.<Tp<Tm−5° C. (3),

Tm−20° C.<Tp<Tm−5° C. (3),

Tm−15° C.<Tp<Tm−5° C. (3),

and/or

Tg<Tb<Tc−55° C. (4).

In embodiments wherein the material (M) is based on PPS, the process may be such that at least one of the inequalities (5) and/or (6) is met:

250° C.<Tp<290° C. (5)

Tb<250° C. (6),

for example

Tb<240° C. (6).

In embodiments wherein the material (M) is based on PAEK, for example PEEK, PEKK or PEK, the process may be such that at least one of the inequalities (5) and/or (6) is met:

300° C.<Tp<340° C. (5)

Tb<300° C. (6),

for example

Tb<290° C. (6).

In embodiments wherein the material (M) is based on a PA comprising repeat units derived from the polycondensation of hexamethylenediamine and adipic acid, the process may be such that at least one of the inequalities (5) and/or (6) is met:

220° C.<Tp<260° C. (5)

Tb<220° C. (6),

for example

Tb<210° C. (6).

In embodiments wherein the material (M) is based on a PPA, the process may be such that at least one of the inequalities (5) and/or (6) is met:

230° C.<Tp<310° C. (5)

Tb<230° C. (6),

for example

Tb<220° C. (6).

A SLS printer includes a first chamber which includes a part bed with heating elements and various sensors/probes, in order to control the temperature of the part bed. A second chamber or set of chambers, adjacent to the first chamber, sometimes referred to as the feed bed, may also be included in the printer and be used to store the material (M) to be used during the printing process. The powdered polymer material (M) may be preheated in this feed bed, prior to being depositing in the sintering chamber. The preheating of the powdered material (M) can reduce or eliminate the thermal gradient present to overcome when raising the temperature of the upper layers of part bed to the processing temperature (Tp). The powdered polymer material (M) can therefore be kept in the feed bed at a feed bed temperature (TO during the printing process. Accordingly, the process of the invention may additionally comprise a step of preheating the powdered polymer material (M) in the feed bed of the SLS printer to a feed bed temperature (Tf). The feed bed temperature is measured and controlled by at least one sensor/probe located in the feed chamber. In this embodiment, the feed bed temperature (Tf) is lower than the processing temperature (Tp). In other words, the following inequality is met: Tf<Tp (7).

The combination of the material (M) and the choice of specific bed temperature (Tb) and processing temperature (Tp), optionally feed bed temperature (Tf) (when the printer is equipped with a feed bed chamber or set of chambers), makes possible the recycling of the unsintered material and its reuse in the manufacture of a new 3D object. The powdered polymer material (M) is less significantly affected by the long-term exposure to the bed temperature (Tb) and processing temperature (Tp), optionally the feed bed temperature (Tf). The mechanical properties of the printed object using adjusted bed temperature and processing temperature are comparable to the object printed at higher temperatures. This not only makes the process of the invention relevant to print objects via SLS (the mechanical properties being preserved), but also makes the used powder more suitable for reuse in a laser sintering 3D printing process, without impacting the appearance and mechanical performances of the resulting printed article (notably the expected performance of the polymer materials, e.g. the toughness of the PAEK).

In some embodiments, the selective sintering is performed by means of a high power energy source, for example a high power laser source such as an electromagnetic beam source. The laser power is preferably less than 30 W, for example less than 25 W, for example in the range between 10 and 25 W.

According to an embodiment, the process of the present invention is such that it does not comprise a step consisting in producing a support structure. According to this embodiment, the under-completion 3D object is not built upon a support structure.

The process of the invention may comprise a predefined and/or controlled cooling step after the 3D object is completed. The predefined and/or controlled cooling step may be realized by predefined slow cooling, possibly slower than native (passive) cooling, or by active cooling in order to provide fast cooling. The 3D object may, for example, be cooled down from the part bed temperature (Tb) to the glass transition temperature (Tg) of the polymer or copolymer (P) at a cooling rate of 0.01-10° C./min, preferably 0.1-5° C./min and more preferably 1-5° C./min. The cooling rate set by means of the temperature control device depends on the type of polymer, copolymer or polymer blend comprised in the material (M). The cooling rate may be selected in order adjust the crystallinity of the 3D object and therefore its mechanical properties (e.g. stiffness, compression strength, impact strength, tensile- and flexural-strength, elongation at break and heat distortion) without comprising the chemical resistance and shrinkage of the 3D object.

The process of the present invention employs a powdered polymer material (M) comprising a semi-crystalline polymer (P) as the main element of the polymer material. The material (M) may also comprise one or several additional polymers (P′, P″, P′″ . . . ). The powdered polymer material (M) can have a regular shape such as a spherical shape, or a complex shape obtained by grinding/milling of pellets or coarse powder.

In some embodiments, the powdered material (M) comprises recycled material (M′). By “recycled”, it should be understood that a material which has already been exposed to the processing temperature of a 3D printer. In some embodiments, the powdered polymer material (M) comprises at least 10 wt. % of recycled powdered material (M′), based on the total weight of the material (M), at least 20 wt. %, at least 30 wt. %, at least 40 wt. %, at least 50 wt. %, at least 60 wt. %, at least 70 wt. %, at least 80 wt. %, at least 90 wt. %, at least 95 wt. % or at least 98 wt. %. The ratio of recycled powdered material (M′)/unrecycled powdered material (M) may for example range from 50/50 to 100/0, preferably 55/45 to 99/1, more preferably 60/40 to 99/1.

The present invention also relates to a recycled powder material (M′), obtainable from an additive manufacturing process for making a three-dimensional (3D) object, that-is-to-say a powder material which has been exposed to the processing temperatures of the 3D printer according to the process of the present invention, presenting a set of properties which still makes it perfectly suited for being used as powder material in the manufacture of a new 3D object. Such a recycled powder material (M′) differs from the unused, pure powder material (M) because it has been exposed to thermal conditions which have generally impacted its properties, for example its Melt Flow Index (MFI) or its Inherent Viscosity (IV). However the conditions employed during the printing process of the present invention are such that these properties are not significantly degraded, thereby allowing unsintered material to be recycled and used in the manufacture of a new 3D object.

In the present application:
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

### Powdered Polymer Material (M)

The powdered polymer material (M) employed in the process of the present invention comprises at least one polymer or copolymer (P) having a melting temperature (Tm) greater than 230° C., as measured by differential scanning calorimetry (DSC) according to ASTM D3418.

The powdered polymer material (M) of the invention may include other components. For example, the material (M) may comprise at least one additive, notably at least one additive selected from the group consisting of flow agents, fillers, colorants, lubricants, plasticizers, stabilizers, flame retardants, nucleating agents and combinations thereof. Fillers in this context can be reinforcing or non-reinforcing in nature. The material (M) may also include one or several additional polymers or copolymers (P′, P″, P′″ . . . ) distinct from polymer (P). In some embodiments, the polymer component in the material (M) consists essentially in one or several semi-crystalline polymers. In some other embodiments, the polymer component in the material (M) consists essentially in one semi-crystalline polymer.

In embodiments that include flow agents, the amount of flow agents in the material (M) ranges from 0.01 to 10 wt. %, with respect to the total weight of the part material.

In embodiments that include fillers, the amount of fillers in the material (M) ranges from 0.1 wt. % to 50 wt. %, or from 0.5 to 40 wt. % or from 1 to 30 wt. %, with respect to the total weight of the material (M). Suitable fillers include calcium carbonate, magnesium carbonate, glass fibers, glass spheres, graphite, carbon black, carbon fibers, carbon nanofibers, graphene, graphene oxide, fullerenes, talc, wollastonite, mica, alumina, silica, titanium dioxide, kaolin, silicon carbide, zirconium tungstate, boron nitride and combinations thereof.

In some embodiments, the material (M) of the present invention comprises from 50 to 99.9 wt. %, from 60 to 99.8 wt. %, from 70 to 99.7 wt. % or from 80 to 99.6 wt. % of at least one polymer (P) having a melting temperature (Tm) greater than 230° C., as measured by differential scanning calorimetry (DSC) according to ASTM D3418,

based on the total weight of the powdered polymer material (M).

In some embodiments, the material (M) of the present invention comprises from 0.1 to 50 wt. % of at least one additive, or from 0.1 to 28 wt. % or from 0.5 to 25 wt. % of at least one additive, for example selected from the group consisting of flow agents, fillers, colorants, dyes, pigments, lubricants, plasticizers, flame retardants (such as halogen and halogen free flame retardants), nucleating agents, heat stabilizer, light stabilizer, antioxidants, processing aids, nanofillers and electomagnetic absorbers, based on the total weight of the powdered polymer material (M).

The polymer or copolymer (P) may selected from the group consisting of a poly(aryl ether ketone) (PAEK), a polyphenylene sulfide (PPS), a semi-aromatic, semi-crystalline polyimide (PI), a polyamide (PA) or a polyphthalamide (PPA), a semi-aromatic polyester and an aromatic polyester (PE), as well as their copolymers and mixtures; it is preferably selected from the group consisting of a poly(aryl ether ketone) (PAEK), a polyphthalamide (PPA) and a polyphenylene sulfide (PPS).

When P is a PAEK, it is preferably selected from the group consisting of a poly(ether ether ketone) (PEEK), a poly(ether ketone ketone) (PEKK), a poly(ether ketone) (PEK), a copolymer of PEEK and poly(diphenyl ether ketone) (PEEK-PEDEK copolymer), and their copolymers and mixtures; even more preferably a PEEK or a PEKK.

When P is a PE, it is preferably selected from the group consisting of a polyethylene terephthalate (PET), polyethylene naphthalate (PEN), a poly(1,4-cyclohexylenedimethylene terephthalate) (PCT), a Liquid Crystalline Polyester (LCP) and their copolymers and mixtures.

When P is a PA or PPA, it preferably contains at least one repeat unit derived from the condensation of a diamine/diacid combination as follows: 6/6, 4/6, 4/10, 4/T, 10/6, 6/C, 6/T, 6/N, 9/T, 9/N, 9/C, 10/T, 10/C, 10/N, PXD/6, PXD/10, PXD/12, PXD/14, PXD/16, PXD/18, MXD/6, BAC/6, BAC/10, BAC/T, BAC/C and BAC/12 and their copolymers and mixtures.

### Poly(Aryl Ether Ketone) (PAEK)

As used herein, a poly(aryl ether ketone) (PAEK) denotes any polymer comprising recurring units (R_{PAEK}) comprising a Ar′—C(═O)—Ar* group, where Ar′ and Ar*, equal to or different from each other, are aromatic groups, the mol. % being based on the total number of moles of recurring units in the polymer. The recurring units (R_{PAEK}) are selected from the group consisting of units of formulas (J-A) to (J-D) below:

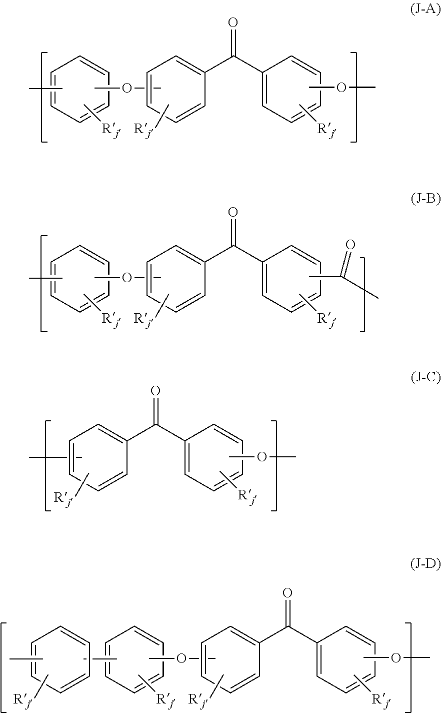

where
R′, at each location, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′ is independently zero or an integer ranging from 1 to 4.

In recurring unit (R_{PAEK}), the respective phenylene moieties may independently have 1,2-, 1,4- or 1,3-linkages to the other moieties different from R′ in the recurring unit (R_{PAEK}). Preferably, the phenylene moieties have 1,3- or 1,4-linkages, more preferably they have a 1,4-linkage.

In recurring units (R_{PAEK}), j′ is preferably at each location zero so that the phenylene moieties have no other substituents than those linking the main chain of the polymer.

According to an embodiment, the PAEK is a poly(ether ether ketone) (PEEK).

As used herein, a poly(ether ether ketone) (PEEK) denotes any polymer comprising recurring units (R_{PEEK}) of formula (J-A), based on the total number of moles of recurring units in the polymer:

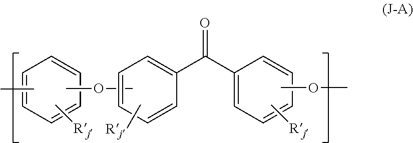

where
R′, at each location, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′, for each R′, is independently zero or an integer ranging from 1 to 4 (for example 1, 2, 3 or 4).

According to formula (J-A), each aromatic cycle of the recurring unit (R_{PEEK}) may contain from 1 to 4 radical groups R′. When j′ is 0, the corresponding aromatic cycle does not contain any radical group R′.

Each phenylene moiety of the recurring unit (R_{PEEK}) may, independently from one another, have a 1,2-, a 1,3- or a 1,4-linkage to the other phenylene moieties. According to an embodiment, each phenylene moiety of the recurring unit (R_{PEEK}), independently from one another, has a 1,3- or a 1,4-linkage to the other phenylene moieties. According to another embodiment yet, each phenylene moiety of the recurring unit (R_{PEEK}) has a 1,4-linkage to the other phenylene moieties.

According to an embodiment, R′ is, at each location in formula (J-A) above, independently selected from the group consisting of a C1-C12 moiety, optionally comprising one or more than one heteroatoms; sulfonic acid and sulfonate groups; phosphonic acid and phosphonate groups; amine and quaternary ammonium groups.

According to an embodiment, j′ is zero for each R′. In other words, according to this embodiment, the recurring units (R_{PEEK}) are according to formula (J′-A):

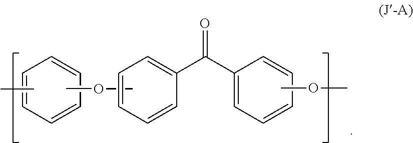

According to another embodiment of the present disclosure, a poly(ether ether ketone) (PEEK) denotes any polymer comprising at least 10 mol. % of the recurring units are recurring units (R_{PEEK}) of formula (J-A″):

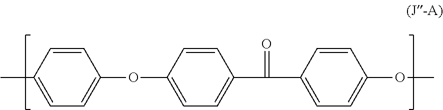

the mol. % being based on the total number of moles of recurring units in the polymer.

According to an embodiment of the present disclosure, at least 10 mol. % (based on the total number of moles of recurring units in the polymer), at least 20 mol. %, at least 30 mol. %, at least 40 mol. %, at least 50 mol. %, at least 60 mol. % , at least 70 mol. %, at least 80 mol. %, at least 90 mol. %, at least 95 mol. %, at least 99 mol. % or all of the recurring units in the PEEK are recurring units (R_{PEEK}) of formulas (J-A), (J′-A) and/or (J″-A).

The PEEK polymer can therefore be a homopolymer or a copolymer. If the PEEK polymer is a copolymer, it can be a random, alternate or block copolymer.

When the PEEK is a copolymer, it can be made of recurring units (R*_{PEEK}), different from and in addition to recurring units (R_{PEEK}), such as recurring units of formula (J-D):

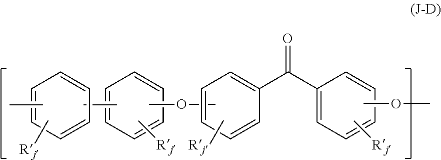

where
R′, at each location, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′, for each R′, is independently zero or an integer ranging from 1 to 4.

According to formula (J-D), each aromatic cycle of the recurring unit (R*_{PEEK}) may contain from 1 to 4 radical groups R′. When j′ is 0, the corresponding aromatic cycle does not contain any radical group R′.

According to an embodiment, R′ is, at each location in formula (J-B) above, independently selected from the group consisting of a C1-C12 moiety, optionally comprising one or more than one heteroatoms; sulfonic acid and sulfonate groups; phosphonic acid and phosphonate groups; amine and quaternary ammonium groups.

According to an embodiment, j′ is zero for each R′. In other words, according to this embodiment, the recurring units (R*_{PEEK}) are according to formula (J′-D):

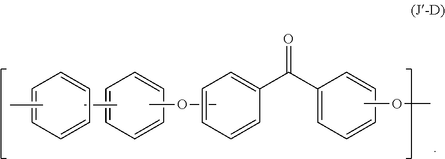

According to another embodiment of the present disclosure, the recurring units (R*_{PEEK}) are according to formula (J″-D):

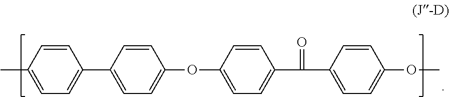

According to an embodiment of the present disclosure, less than 90 mol. % (based on the total number of moles of recurring units in the polymer), less than 80 mol. %, less than 70 mol. %, less than 60 mol. %, less than 50 mol. %, less than 40 mol. %, less than 30 mol. %, less than 20 mol. %, less than 10 mol. %, less than 5 mol. %, less than 1 mol. % or all of the recurring units in the PEEK are recurring units (R*_{PEEK}) of formulas (J-B), (J′-B), and/or (J″-B).

According to an embodiment, the PEEK polymer is a PEEK-PEDEK copolymer. As used herein, a PEEK-PEDEK copolymer denotes a polymer comprising recurring units (R_{PEEK}) of formula (J-A), (J′-A) and/or (J″-A) and recurring units (R*_{PEEK}) of formulas (J-B), (J′-B) or (J″-B) (also called hereby recurring units (R_{PEDEK})). The PEEK-PEDEK copolymer may include relative molar proportions of recurring units (R_{PEEK}/R_{PEDEK}) ranging from 95/5 to 5/95, from 90/10 to 10/90, or from 85/15 to 15/85. The sum of recurring units (R_{PEEK}) and (R_{PEDEK}) can for example represent at least 60 mol. %, 70 mol. %, 80 mol. %, 90 mol. %, 95 mol. %, 99 mol. %, of recurring units in the PEEK copolymer. The sum of recurring units (R_{PEEK}) and (R_{PEDEK}) can also represent 100 mol. %, of recurring units in the PEEK copolymer.

Defects, end groups and monomers' impurities may be incorporated in very minor amounts in the polymer (PEEK) of the present disclosure, without undesirably affecting the performance of the polymer in the polymer composition (C1).

PEEK is commercially available as KetaSpire® PEEK from Solvay Specialty Polymers USA, LLC.

PEEK can be prepared by any process known in the art. It can for example result from the condensation of 4,4′-difluorobenzophenone and hydroquinone in presence of a base. The reactor of monomer units takes place through a nucleophilic aromatic substitution. The molecular weight (for example the weight average molecular weight Mw) can be adjusting the monomers molar ratio and measuring the yield of polymerisation (e.g. measure of the torque of the impeller that stirs the reaction mixture).

According to one embodiment of the present disclosure, the PEEK polymer has a weight average molecular weight (Mw) ranging from 75,000 to 100,000 g/mol, for example from 77,000 to 98,000 g/mol, from 79,000 to 96,000 g/mol, from 81,000 to 95,000 g/mol, or from 85,000 to 94,500 g/mol (as determined by gel permeation chromatography (GPC) using phenol and trichlorobenzene (1:1) at 160° C., with polystyrene standards).

The powdered polymer material (M) of the invention may comprise PEEK in an amount of 55 to 95 wt. %, for example less than 60 to 90 wt. %, based on the total weight of M.

According to the present invention, the melt flow rate or melt flow index (at 400° C. under a weight of 2.16 kg according to ASTM D1238) (MFR or MFI) of the PEEK may be from 1 to 60 g/10 min, for example from 2 to 50 g/10 min or from 2 to 40 g/10 min.

In another embodiment, the PAEK is a poly(ether ketone ketone) (PEKK).

As used herein, a poly(ether ketone ketone) (PEKK) denotes a polymer comprising more than 50 mol. % of the recurring units of formulas (J-B₁) and (J-B₂), the mol. % being based on the total number of moles of recurring units in the polymer:

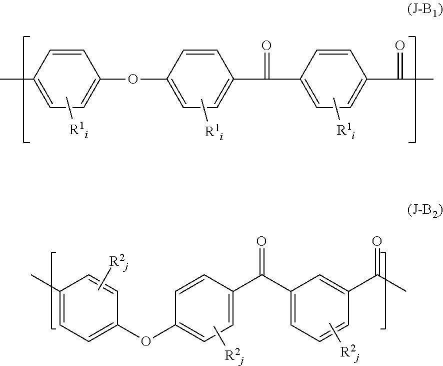

wherein

R¹ and R², at each instance, is independently selected from the group consisting of an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; and i and j, at each instance, is an independently selected integer ranging from 0 to 4.

According to an embodiment, R¹ and R² are, at each location in formula (J-B₂) and (J-B₁) above, independently selected from the group consisting of a C1-C12 moiety, optionally comprising one or more than one heteroatoms; sulfonic acid and sulfonate groups; phosphonic acid and phosphonate groups; amine and quaternary ammonium groups.

According to another embodiment, i and j are zero for each R¹ and R² group. According to this embodiment, the PEKK polymer comprises at least 50 mol. % of recurring units of formulas (J′-B₁) and (J′-B₂), the mol. % being based on the total number of moles of recurring units in the polymer:

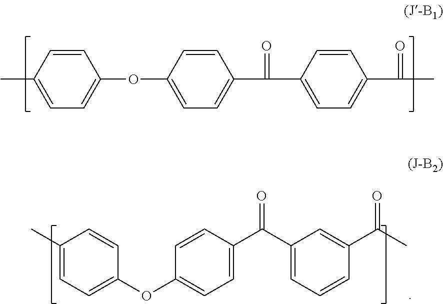

According to an embodiment of the present disclosure, at least 55 mol. %, at least 60 mol. %, at least 70 mol. %, at least 80 mol. %, at least 90 mol. %, at least 95 mol. %, at least 99 mol. % or all of the recurring units in the PEKK are recurring units of formulas (J-B₁) and (J-B₂).

According to an embodiment of the present disclosure, in the PEKK polymer, the molar ratio of recurring units (J-B₂) or/and (J′-B₂) to recurring units (J-B₁) or/and (J′-B₁) is at least 1:1 to 5.7:1, for example at least 1.2:1 to 4:1, at least 1.4:1 to 3:1 or at least 1.4:1 to 1.86:1.

The PEKK polymer has preferably an inherent viscosity of at least 0.50 deciliters per gram (dL/g), as measured following ASTM D2857 at 30° C. on 0.5 wt./vol. % solutions in concentrated H₂SO₄ (96 wt. % minimum), for example at least 0.60 dL/g or at least 0.65 dL/g and for example at most 1.50 dL/g, at most 1.40 dL/g, or at most 1.30 dL/g.

PEKK is commercially available as NovaSpire® PEKK from Solvay Specialty Polymers USA, LLC

### Polyphenylene Sulfide (PPS)

As used herein, a polyphenylene sulfide (PPS) denotes any polymer comprising at least 50 mol. % of recurring units (R_{PPS}) of formula (U) (mol. % being based on the total number of moles of recurring units in the PPS polymer):

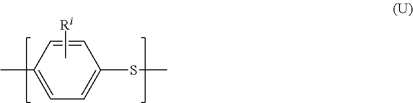

where

R is independently selected from the group consisting of halogen, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and

i is independently zero or an integer from 1 to 4.

According to formula (U), the aromatic cycle of the recurring unit (R_{PPS}) may contain from 1 to 4 radical groups R. When i is zero, the corresponding aromatic cycle does not contain any radical group R.

According to an embodiment of the present invention, the PPS polymer denotes any polymer comprising at least 50 mol. % of recurring units (R_{PPS}) of formula (U′) where i is zero:

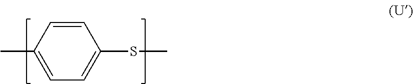

According to an embodiment of the present invention, the PPS polymer is such that at least 60 mol. %, at least 70 mol. %, at least 80 mol. %, at least 90 mol. %, at least 95 mol. %, at least 99 mol. % of the recurring units in the PPS are recurring units (R_{PPS}) of formula (U) or (U′). The mol. % are based are based on the total number of moles of recurring units in the PPS polymer.

According to an embodiment of the present invention, the PPS polymer is such that 100 mol. % of the recurring units are recurring units (R_{PPS}) of formula (U) or (U′). According to this embodiment, the PPS polymer consists essentially of recurring units (R_{PPS}) of formula (U) or (U′).

PPS is commercially available under the tradename Ryton® PPS from Solvay Specialty Polymers USA, LLC.

The melt flow rate (at 316° C. under a weight of 5 kg according to ASTM D1238, procedure B) of the PPS may be from 50 to 400 g/10 min, for example from 60 to 300 g/10 min or from 70 to 200 g/10 min.

### Polyamide (PA) and Polyphthalamide (PPA)

When P is a PA or PPA, it preferably contains at least one repeat unit derived from the condensation of a diamine/diacid combination as follows: 6/6, 4/6, 4/10, 4/T, 10/6, 6/C, 6/T, 6/N, 9/T, 9/N, 9/C, 10/T, 10/C, 10/N, PXD/6, PXD/10, PXD/12, PXD/14, PXD/16, PXD/18, MXD/6, BAC/6, BAC/10, BAC/T, BAC/C and BAC/12, as well as their copolymers and mixtures.

As used herein, a polyphthalamide (PPA) denotes any polymer comprising at least 50 mol. % of recurring units (R_{PPA}) (based on the total number of moles in the polymer) formed by the polycondensation of at least phthalic acid and at least aliphatic diamine. The phthalic acid can for example be selected from the group consisting of o-phthalic acid, isophthalic acid and terephthalic acid.

The aliphatic diamine can for example be selected from the group consisting of hexamethylenediamine, 1,9-nonanediamine, 1,10-diaminodecane, 1,12-diaminododecane, 2-methyl-octanediamine, 2-methyl-1,5-pentanediamine, 1,4-diaminobutane. C6 diamines are preferred, in particular hexamethylenediamine.

Among polyphthalamides (PPA), polyterephthalamides (PTPA) are preferred. Polyterephthalamides are aromatic polyamides comprising at least 50 mol. % of recurring units (R_{PTPA}) formed by the polycondensation of at least terephthalic acid (TPA) and at least one aliphatic diamine.

According to a first embodiment, the polyterephthalamides (PTPA) comprise at least 60 mol. %, at least 70 mol. %, at least 70 mol. %, at least 80 mol. %, at least 90 mol. %, at least 95 mol. % or at least 99 mol. % of recurring units (R_{PTPA}) formed by the polycondensation of at least terephthalic acid (TPA) and at least one aliphatic diamine. According to this embodiment, a preferred diamine is a C6 diamine and/or a C9 diamine and/or C10 diamine.

According to a second embodiment, the polyterephthalamides (PTPA) comprise recurring units formed by the polycondensation of terephthalic acid (PTA), isophthalic acid (IPA) and at least one aliphatic diamine. According to this embodiment, a preferred polyterephthalamide comprises at least 50 mol. % or consists essentially of recurring units formed by the polycondensation of terephthalic acid (PTA) and at least one aliphatic diamine and of recurring units formed by the polycondensation of isophthalic acid (IPA) and at least one aliphatic diamine, in a mole ratio ranging between 60:40 and 90:10 (mol. %).

According to a third embodiment, the polyterephthalamides (PTPA) comprise recurring units formed by the polycondensation reaction between terephthalic acid (TPA), at least one aliphatic diacid and at least one aliphatic diamine. The aliphatic diacid can for example be selected from the group consisting of adipic acid and sebacic acid. Adipic acid is preferred. According to this embodiment, a preferred polyterephthalamide comprises at least 50 mol. % or consists essentially of recurring units formed by the polycondensation of terephthalic acid (TPA) and at least one aliphatic diamine and of recurring units formed by the polycondensation of at least one aliphatic diacid and at least one aliphatic diamine, in a mole ratio ranging between 55:45 and 75:25 (mol. %).

According to a fourth embodiment, the polyterephthalamides (PTPA) comprise recurring units formed by the polycondensation of terephthalic acid (TPA), isophthalic acid (IPA), at least one aliphatic diacid and at least one aliphatic diamine. The aliphatic diacid can for example be selected from the group consisting of adipic acid and sebacic acid. Adipic acid is preferred. According to this embodiment, a preferred polyterephthalamide comprises at least 50 mol. % or consists essentially of recurring units (R1) formed by the polycondensation of terephthalic acid (TPA) and at least one aliphatic diamine, of recurring units (R2) formed by the polycondensation of isophthalic acid (IPA) and at least one aliphatic diamine, and of recurring units (R3) formed by the polycondensation of at least one aliphatic diacid and at least one aliphatic diamine. In this case, the mole ratio of recurring units (R1): (R2)+(R3) may range from 55:45 to 75:25 (mol %) and the mole ratio (R2):(R3) may range from 60:40 to 85:15.

The polyphthalamide (PPA) is semi-crystalline. The melting point of the PPA may be greater than 275° C., preferably greater than 290° C., more preferably greater than 305° C., and still more preferably greater than 320° C.

PPA is commercially available under the tradename Amodel® from Solvay Specialty Polymers USA, LLC.

### Semi-Aromatic and Aromatic Polyesters (PE).

As used herein, a semi-aromatic or aromatic polyesters denotes any polymer comprising at least 50 mol. %, of recurring units (R_{PE}) comprising at least one ester moiety of formula R—COO—R and at least one aromatic moiety.

The polyesters of the present invention may be obtained by polycondensation of an aromatic monomer (MA) comprising at least one hydroxyl group and at least one carboxylic acid group or by polycondensation of at least one monomer (MB) comprising at least two hydroxyl groups (a diol) and at least one monomer (MC) comprising at least two carboxylic acid groups (a dicarboxylic acid), with at least one of the monomers (MB) or (MC) comprising an aromatic moiety.

Non limitative examples of monomers (MA) include 4 hydroxybenzoic acid, 6-hydroxynaphthalene-2-carboxylic acid.

Non limitative examples of monomers (MB) include 1,4 cyclohexanedimethanol; ethylene glycol; 1,4-butanediol; 1,3-propanediol; 1,5 pentanediol, 1,6-hexanediol; and neopentyl glycol, while 1,4 cyclohexanedimethanol and neopentyl glycol are preferred.

Non limitative examples of monomers (MC) include terephthalic acid, isophthalic acid, naphthalene dicarboxylic acids, cyclohexane dicarboxylic acid, succinic acid, sebacic acid, and adipic acid, while terephthalic acid and cyclohexane dicarboxylic acid are preferred.

Depending on the choice of monomers, polyesters (PE) can be either wholly semi-aromatic or aromatic. They can be copolymers or homopolymers.

According to an embodiment, when the polyester of the invented composition is a copolymer, at least 50 mol. %, at least 60 mol. %, at least 70 mol. %, at least 80 mol. %, or at least 90 mol. % of the recurring units are obtained through the polycondensation of terephthalic acid.

According to another embodiment, when the polyester of the invented composition is a copolymer, at least 50 mol. %, at least 60 mol. %, at least 70 mol. %, at least 80 mol. %, or at least 90 mol. % of the recurring units are obtained through the polycondensation of terephthalic acid with 1,4-cyclohexylenedimethanol.

When the polyester of the invented composition is a homopolymer, it may be selected from the group consisting of a polyethylene terephthalate (PET), polyethylene naphthalate (PEN), a poly(1,4 cyclohexylenedimethylene terephthalate) (PCT), and a Liquid Crystalline Polyester (LCP). It is preferably a PCT (i.e. a homopolymer obtained through the polycondensation of terephthalic acid with 1,4-cyclohexylenedimethanol).

The polyesters used herein have advantageously an intrinsic viscosity of from about 0.6 to about 2.0 dl/g as measured in a 60:40 phenol/tetrachloroethane mixture or similar solvent at about 30° C. Particularly suitable polyesters for this invention have an intrinsic viscosity of 0.6 to 1.4 dl/g.

The melting temperature (Tm) of the PE may be greater than 240° C., and still more preferably greater than 280° C.

### Optional Components

The powdered polymer material (M) of the present invention may further comprise a flow agent, also called sometimes flow aid. This flow agent may for example be hydrophilic. Examples of hydrophilic flow aids are inorganic pigments notably selected from the group consisting of silicas, aluminas and titanium oxide. Mention can be made of fumed silica.

Fumed silicas are commercially available under the trade name Aerosil® (Evonik) and Cab-O-Sil® (Cabot).

According to an embodiment of the present invention, the powdered polymer material (M) comprises from 0.01 to 10 wt. %, preferably from 0.05 to 5 wt. %, more preferably from 0.25 to 1 wt. %, of a flow agent, for example of fumed silica.

These silicas are composed of nanometric primary particles (typically between 5 and 50 nm for fumed silicas). These primary particles are combined to form aggregates. In use as flow agent, silicas are found in various forms (elementary particles and aggregates).

The powdered polymer material (M) of the present invention may further comprise one or several additives, such as lubricants, heat stabilizers, light stabilizers, antioxidants, pigments, processing aids, dyes, fillers, nanofillers or electomagnetic absorbers. Examples of these optional additives are titanium dioxide, zinc oxide, cerium oxide, silica or zinc sulphide, glass fibers, carbon fibers.

The powdered polymer material (M) of the present invention may further comprise flame retardants such as halogen and halogen free flame retardants.

The process for the production of the powdered polymer material (M) used in the process of the invention may comprise: a) a step of mixing the material (M)'s components together, in case several are used, for example blend compounding the polymers, in case the material (M) contains several polymers or copolymers, and b) a step of grinding the resulting blended formulation, for example in the form of pellets, in order to obtain a powdered polymer material (M) having a d₅₀-value ranging from 20 from 100 μm, as measured by laser scattering in isopropanol. The d₅₀, also called D50, is known as the median diameter or the medium value of the particle size distribution, it is the value of the particle diameter at 50% in the cumulative distribution. It means that 50% of the particles in the sample are larger than the d₅₀-value, and 50% of the particles in the sample are smaller than the d₅₀-value. D50 is usually used to represent the particle size of group of particles.

According to the present invention, the powder has a d₅O-value comprised between 20 μm and 100 μm, as measured by laser scattering in isopropanol, preferably between 30 μm and 80 μm, or between 35 μm and 70 μm or between 40 μm and 60 μm.

According to an embodiment of the present invention, the powder has a d₉₀-value less than 120 μm, as measured by laser scattering in isopropanol. According to an embodiment, the powder has a d₉₀-value less than 115 μm, as measured by laser scattering in isopropanol, preferably less than 110 μm or less 105 μm.

According to an embodiment of the present invention, the powder has a d₁₀-value higher than 15 μm, as measured by laser scattering in isopropanol. According to an embodiment, the powder has a d₁₀-value higher than 20 μm, as measured by laser scattering in isopropanol, preferably higher than 25 μm or higher than 28 μm.

The pellets of blended formulations can for example be ground in a pinned disk mill, a jet mill/fluidized jet mil with classifier, an impact mill plus classifier, a pin/pin-beater mill or a wet grinding mill, or a combination of those equipment.

The pellets of blended formulations can be cooled before step c) to a temperature below the temperature at which the material becomes brittle, for example below 25° C. before being ground.

The step of grinding can also take place with additional cooling. Cooling can take place by means of liquid nitrogen or dry ice.

The ground powder can be separated, preferably in an air separator or classifier, to obtain a predetermined fraction spectrum.

The process for the production of a powdered polymer material (M) may further comprise a step consisting in exposing the material (M) or the polymer (P) to a temperature (Ta) ranging from the glass transition temperature (Tg) of the polymer (P), for example the PAEK polymer, and the melting temperature (Tm) of the polymer (P), for example the PAEK polymer, both Tg and Tm being measured using differential scanning calorimetry (DSC) according to ASTM D3418. The temperature Ta can be selected to be at least 20° C. above the Tg of the polymer (P), for example the PAEK polymer, for example at least 30, 40 or 50° C. above the Tg of the polymer or copolymer (P), for example of the PAEK polymer. The temperature Ta can be selected to be at least 5° C. below the Tm of the polymer (P), for example the PAEK polymer, for example at least 10, 20 or 30° C. below the Tm of the polymer (P), for example the PAEK polymer. The exposition of the material (M) or the polymer or copolymer (P) to the temperature Ta can for example be by heat-treatment and can take place in an oven (static, continuous, batch, convection), fluid bed heaters. The exposition of the powder to the temperature Ta can alternatively be by irradiation with electromagnetic or particle radiation. The heat treatment can be conducted under air or under inert atmosphere. Preferably, the heat treatment is conducted under inert atmosphere, more preferably under an atmosphere containing less than 2% oxygen.

The process for the production of a powdered polymer material (M) may further comprise a step consisting in mechanically densifying the powdered polymer material (M), using the equipment known to the skilled person in the art.

### Recycled Powder Material (M′)

The adjustment of the printing temperatures used to process the powder material into a 3D object and then keep it until the 3D object is completed are such that they allow the manufacture of good 3D objects via SLS and the recycling of the unsintered powder material (M′).

The present invention thereby relates to a recycled powder material (M′), obtainable from an additive manufacturing process for making a three-dimensional (3D) object. The temperatures employed during the printing process are such that they impact the properties of the pure powder material (M), in such a way that M′ is not identical to M, as demonstrated in the examples of the present invention. The inventors indeed demonstrate that the Melt Flow Index (MFI) or Inherent Viscosity (IV) of the powder material is impacted by the processing temperatures of the process but measuring the Melt Flow Index (MFI) change of unsintered powder after printing. While the powder material used in the process of the present invention is impacted by the printing conditions defined in the present invention, the impact on the properties is significantly lower in comparison to printing conditions outside the scope of the present process.

In some embodiments, the recycled powdered material (M′) has a ΔMFI≤90%, preferably 80%, more preferably 75%,

wherein:

ΔMFI=100×|(MFIₜ₀−MFIₜ₁)/MFIₜ₀|

wherein:

MFI is the Melt Flow Index as measured by ASTM D-1238,

MFIₜ₀ is the MFI of the powder before printing,

MFIₜ₁ is the MFI of the unsintered powder after printing.

The melt flow indices of the polymers are measured according to ASTM D-1238, using the following weights and temperatures: for PPS, a weight of 5 kg and a temperature of 316° C.; for PAEK, a weight of 2.16 kg and a temperature of 420° C.; for PEEK, a weight of 2.16 kg and a temperature of 400° C.; and for PPA, a weight of 2.16 kg and a temperature of 343° C.

In some embodiments, the recycled powdered material (M′) has an inherent viscosity change or ΔIV≤50%, preferably less than 40%, more preferably less than 75%,

### Wherein:

ΔIV=100×|(IVₜ₀−IVₜ₁)/IVₜ₀|

wherein:

IV is the Inherent Viscosity as measured by ASTM D-5336,

IVₜ₀ is the IV of the powder before printing,

IVₜ₁ is the IV of the unsintered powder after printing.

3D Objects and Articles

The 3D objects or articles obtainable by such process of manufacture can be used in a variety of final applications. Mention can be made in particular of implantable device, medical device, dental prostheses, brackets and complex shaped parts in the aerospace industry and under-the-hood parts in the automotive industry.

Should the disclosure of any patents, patent applications, and publications which are incorporated herein by reference conflict with the description of the present application to the extent that it may render a term unclear, the present description shall take precedence.

### EXAMPLES

The disclosure will be now be described in more detail with reference to the following examples, whose purpose is merely illustrative and not intended to limit the scope of the disclosure.

### Starting Materials

PPS: a polyphenylene sulfide (PPS) polymer with a Calcium content=56 ppm was prepared according to the process described below.

PPS was synthesized and recovered from the reaction mixture according to methods described in U.S. Pat. Nos. 3,919,177 and 4,415,729, washed with deionized water for at least 5 minutes at 60° C., then contacted with an aqueous acetic acid solution having a pH of <6.0 for at least 5 minutes at 60° C., and subsequently rinsed with deionized water at 60° C.

TABLE 1

| | PPS |
|---|---|
| MFI (316° C./5 kg) | 100 g/10 min |
| Tm (° C.) | 290 |
| Tg (° C.) | 90 |
| Tc (° C.) | 220 |

PAEK: a polyaryletherketone (PAEK) polymer was commercially obtained from EOS of North America, Inc., under the product name of EOS PEEK HP3 Polyaryletherketone Powder.

TABLE 2

| | PAEK |
|---|---|
| MFI (420° C./2.16 kg) | 36 g/10 min |
| Tm (° C.) | 375 |
| Tg (° C.) | 160 |
| Tc (° C.) | 330 |

PEEK: a polyetheretherketone (PEEK) polymer was prepared according to the process described below.

In a 500 ml 4-neck reaction flask fitted with a stirrer, a N2 inlet tube, a Claisen adapter with a thermocouple plunging in the reaction medium, and a Dean-Stark trap with a condenser and a dry ice trap were introduced 128 g of diphenyl sulfone, 28.6 g of p-hydroquinone, and 57.2 g of 4,4′-difluorobenzophenone.

The reaction mixture was heated slowly to 150° C. At 150° C., a mixture of 28.43 g of dry Na₂CO₃ and 0.18 g of dry K₂CO₃ was added via a powder dispenser to the reaction mixture over 30 minutes. At the end of the addition, the reaction mixture was heated to 320° C. at 1° C./minute.

After longer than 15 to 30 minutes, when the polymer had the expected Mw, the reaction was stopped by the introduction of 6.82 g of 4,4′-difluorobenzophenone to the reaction mixture while keeping a nitrogen purge on the reactor. After 5 minutes, 0.44 g of lithium chloride were added to the reaction mixture. 10 minutes later, another 2.27 g of 4,4′-difluorobenzophenone were added to the reactor and the reaction mixture was kept at temperature for 15 minutes. The reactor content was then cooled. The solid was broken up and ground. The polymer was recovered by filtration of the salts, washing and drying.

TABLE 3

| | PEEK |
|---|---|
| MFI (400° C./2.16 kg) | 6 g/10 min |
| Tm (° C.) | 340 |
| Tg (° C.) | 150 |
| Tc (° C.) | 275 |

PPA: a high-performance 9/T-based semiaromatic polyamide (PPA) polymer was obtained from Kuraray Company, LTD, under the product name of Genestar™ GC98018.

TABLE 4

| | PPA |
|---|---|
| MFI (343° C./2.16 kg) | 59 g/10 min |
| IV (dL/g) | 1.23 |
| Tm (° C.) | 266 |
| Tg (° C.) | 121 |
| Tc (° C.) | 225 |

Cab-O-Sil® M-5 is a fumed silica commercially available from Cabot Corporation.

### Preparation of Powders

Powders were generated from the PPS starting material by mechanical grinding using a rotor mill. The PPS was then blended with 0.3% fumed silica via drum rolling and sieved through a No. 120 mesh tensile bolting cloth (pore size of 147 μm).

TABLE 5

| PSD | PPS #1 | PPS #2 |
|---|---|---|
| d_{0.5} | 74 | 50 |
| d_{0.9} | 108 | 79 |
| d_{0.1} | 50 | 33 |

The PAEK material was obtained commercially already in powder form.

TABLE 6

| PSD | PAEK |
|---|---|
| d_{0.5} | 50 |
| d_{0.9} | 98 |
| d_{0.1} | 27 |

Powders were generated from the PEEK starting material by mechanical grinding using a rotor mill. The PEEK was then blended with 0.3% fumed silica via drum rolling and sieved through a No. 100 U.S. sieve (pore size of 150 μm).

TABLE 7

| PSD | PEEK |
|---|---|
| d_{0.5} | 65 |
| d_{0.9} | 128 |
| d_{0.1} | 31 |

Powders were generated from the PPA starting material via jet milling under cryo-grinding conditions. The PPA was then blended with 0.3% fumed silica via drum rolling and sieved through a No. 100 U.S. sieve (pore size of 150 μm).

TABLE 8

| PSD | PPA |
|---|---|
| d_{0.5} | 45 |
| d_{0.9} | 83 |
| d_{0.1} | 19 |

### Test Methods

### Thermal Transitions (Tg, Tm, Tc)

The glass transition, melting and crystallisation temperatures of the polymer were measured using differential scanning calorimetry (DSC) according to ASTM D3418 employing a heating and cooling rate of 20° C./min. Three scans were used for each DSC test: a first heat up to the maximum temperature, followed by a first cool down to 30° C., followed by a second heat up to the maximum temperature. The Tm is determined from the first heat up. The Tc is determined from the first cool down. The Tg is determined from the second heat up. For the PPS material, the maximum temperature was 350° C. For the PAEK and PEEK material, the maximum temperature was 400° C. DSC was performed on a TA Instruments DSC Q20 with nitrogen as carrier gas (99.998% purity, 50 mL/min).

### Melt Flow Index (MFI)

The melt flow indices of the polymers were measured according to ASTM D-1238, using the following weights and temperatures: for PPS, a weight of 5 kg and a temperature of 316° C. were used; for PAEK, a weight of 2.16 kg and a temperature of 420° C. were used; for PEEK, a weight of 2.16 kg and a temperature of 400° C. were used; and for PPA, a weight of 2.16 kg and a temperature of 343° C. were used. The measurements were conducted on a Dynisco D4001 Melt Flow Indexer.

### Inherent Viscosity (IV)

The inherent viscosity of the polymers was measured according to ASTM D-5336. The polymers were dissolved in phenol-tetrachloroethane (P:TCE=60:40) heated at 100° C. for 45 minutes. After cooling, the solution was injected into a Viscotek Viscometer (Y500 series) equipped with a dispensing pump and an autosampler. The equipment then determined the sample IV based on the differential pressures of the solvent blank and PPA solution.

PSD (d_{0.5}, d_{0.1}, d_{0.9})

The PSD (volume distribution) of the powdered polymer materials were determined by an average of 3 runs using laser scattering Microtrac S3500 analyzer in wet mode (128 channels, between 0.0215 and 1408 μm). The solvent was isopropanol with a refractive index of 1.38 and the particles were assumed to have a refractive index of 1.59 for the PPS, PAEK, and PEEK, and a refractive index of 1.53 for the PPA. The ultrasonic mode was enabled (25 W/60 seconds) and the flow was set at 55%.

### Mechanical Testing

ASTM Type I tensile bars were tested according to ASTM D638, where the result reported is an average from 5 bars.

### Disaggregation

Unsintered powder was separated from the printed parts after printing and evaluated for disaggregation, a measure of potential recyclability to return the powder particles to free-flowing form.
where the following definitions can be used to evaluate the unsintered powder:
1=Easy Disaggregation: Powder particles of the unsintered powder are not closely associated together and the powder can be very easily reverted back into free-flowing powder.
2=Difficult Disaggregation: Powder particles of the unsintered powder are closely associated together but can be broken back apart with effort by traditional sieving.Printing

Printing occurred on an EOSINT® P800 SLS Printer, with the processing and bed temperatures dependent by example (see below). Other relevant print settings include a hatch laser power of 17 watts, contour laser power of 8.5 watts, laser speed of 2.65 m/s, and cooling rate after print completion of less than 10° C./min. The powder was sintered into ASTM Type I tensile bars.

### Results

TABLE 9

| | E1c | E2 | E3c |
|---|---|---|---|
| Powder | PPS #1 | PPS #2 | PPS #2 |
| Processing temperature Tp | 285 | 275 | 200 |
| (° C.) | | | |
| Part bed temperature Tb (° C.) | 273 | 200 | 200 |
| Ultimate Tensile Strength | 53 | 53 | layer curling occurred; |
| (MPa) | | | printing not possible; |
| | | | print failure |
| Ultimate Tensile Strength | 2.4 | 1.8 | layer curling occurred; |
| Standard Deviation (MPa) | | | printing not possible; |
| | | | print failure |
| Melt Flow Index (MFI) | 86 | 64 | could not be evaluated |
| change of unsintered powder | | | because of print failure |
| after printing (%) | | | |
| Disaggregation | 2 | 1 | could not be evaluated |
| | | | because of print failure |
| Powder Aspect of unsintered | Dark | Light | could not be evaluated |
| powder after printing | Brown | Brown | because of print failure |

Example 1c is comparative, inequality (4) is unmet.

Example 2 is invention, all inequalities (1)-(4) are met.

Example 3c is comparative, inequalities (2) and (3) are unmet.

When reducing the part bed temperature from 273° C. to 200° C. (E2 vs. E1c), the same magnitude of tensile strength is achieved. The MFI change (or Δ MFI) for the inventive example E2 is significantly lower in comparison to comparative example E1c, which means that the MFI is preserved when the thermal conditions of the process of the invention are applied. Disaggregation of the unsintered powder after printing is easier when the printing was run under the thermal conditions of the inventive example E2. Additionally, the unsintered powder has a better aspect (light brown versus dark brown). Reducing the temperature of the part bed (Tb) not only has beneficial effects on PPS stability, longevity and recyclability of the PPS material, and reduces the energy consumption during the printing process, but also allows preservation of the mechanical performance of the printed object.

Comparative example E3c however demonstrates that if both the part bed temperature (Tb) and the processing temperature (Tp) are reduced to 200° C., the currently sintering layer instantly begins to crystallize and curl. This causes print failure and an inability to continue printing.

TABLE 10

| | E4c | E5 | E6c |
|---|---|---|---|
| Powder | PAEK | PAEK | PAEK |
| Processing temperature Tp | 363 | 363 | 275 |
| (° C.) | | | |
| Part bed temperature Tb (° C.) | 345 | 275 | 275 |
| Ultimate Tensile Strength | 95 | 90 | layer curling occurred; |
| (MPa) | | | printing not possible; |
| | | | print failure |
| Ultimate Tensile Strength | 7.1 | 5.8 | layer curling occurred; |
| Standard Deviation (MPa) | | | printing not possible; |
| | | | print failure |
| Melt Flow Index (MFI) | 99 | 91 | could not be evaluated |
| change of unsintered powder | | | because of print failure |
| after printing (%) | | | |
| Disaggregation | 1 | 1 | could not be evaluated |
| | | | because of print failure |
| Powder Aspect of unsintered | Light | Light | could not be evaluated |
| powder after printing | Brown | Brown | because of print failure |

Example 4c is comparative, inequality (4) is unmet.

Example 5 is invention, all inequalities (1)-(4) are met.

Example 6c is comparative, inequalities (2) and (3) are unmet.

When reducing the part bed temperature from 345° C. to 275° C. (E5 vs. E4c), and when taking into account the standard deviation, the same magnitude of tensile strength is achieved. The MFI change (or ΔMFI) for the inventive example E5 is lower in comparison to comparative example E4c, which means that the MFI is preserved when the thermal conditions of the process of the invention are applied. Reducing the temperature of the part bed (Tb) not only has beneficial effects on PAEK stability and recyclability of the PAEK material, and reduces the energy consumption during the printing process, but also allows preservation of the mechanical performance of the printed object.

Comparative example E6c however demonstrates that if both the part bed temperature (Tb) and the processing temperature (Tp) are reduced to 275° C., the currently sintering layer instantly begins to crystallize and curl. This causes print failure and an inability to continue printing.

TABLE 11

| | E7c | E8 | E9c |
|---|---|---|---|
| Powder | PEEK | PEEK | PEEK |
| Processing temperature Tp | 325 | 325 | 250 |
| (° C.) | | | |
| Part bed temperature Tb (° C.) | 305 | 250 | 250 |
| Ultimate Tensile Strength | 94 | 94 | layer curling occurred; |
| (MPa) | | | printing not possible; |
| | | | print failure |
| Ultimate Tensile Strength | 0.8 | 0.7 | layer curling occurred; |
| Standard Deviation (MPa) | | | printing not possible; |
| | | | print failure |
| Melt Flow Index (MFI) | 6.6 | 5.1 | could not be evaluated |
| change of unsintered powder | | | because of print failure |
| after printing (%) | | | |
| Disaggregation | 1 | 1 | could not be evaluated |
| | | | because of print failure |
| Powder Aspect of unsintered | White | White | could not be evaluated |
| powder after printing | | | because of print failure |

Example 7c is comparative, inequality (4) is unmet.

Example 8 is invention, all inequalities (1)-(4) are met.

Example 9c is comparative, inequalities (2) and (3) are unmet.

When reducing the part bed temperature from 305° C. to 250° C. (E8 vs. E7c), the same magnitude of tensile strength is achieved. The MFI change (or Δ MFI) for the inventive example E8 is lower in comparison to comparative example E7c, which means that the MFI is preserved when the thermal conditions of the process of the invention are applied. Reducing the temperature of the part bed (Tb) not only has beneficial effects on PEEK stability and recyclability of the PEEK material, and reduces the energy consumption during the printing process, but also allows preservation of the mechanical performance of the printed object.

Comparative example E9c however demonstrates that if both the part bed temperature (Tb) and the processing temperature (Tp) are reduced to 250° C., the currently sintering layer instantly begins to crystallize and curl. This causes print failure and an inability to continue printing.

TABLE 12

| | E10c | E11 | E12c |
|---|---|---|---|
| Powder | PPA | PPA | PPA |
| Processing temperature Tp | 260 | 260 | 190 |
| (° C.) | | | |
| Part bed temperature Tb (° C.) | 245 | 190 | 190 |
| Inherent Viscosity (IV) | Did not | 19.5 | layer curling occurred; |
| change of unsintered powder | go into | | printing not possible; |
| after printing (%) | solution | | print failure |
| Disaggregation | 2 | 1 | layer curling occurred; |
| | | | printing not possible; |
| | | | print failure |
| Powder Aspect of unsintered | Dark | Light | layer curling occurred; |
| powder after printing | Brown | Brown | printing not possible; |
| | | | print failure |

Example 10c is comparative, inequality (4) is unmet.

Example 11 is invention, all inequalities (1)-(4) are met.

Example 12c is comparative, inequalities (2) and (3) are unmet.

When reducing the part bed temperature from 245° C. to 190° C. (E10c vs. E11), the IV of the inventive example E11 demonstrates a change (or ΔIV) of only 19.5%. Alternatively, the IV of the comparative example E10c cannot be measured because the material could not be dissolved in solution. This indicates significant negative effects on the PPA stability. Reducing the temperature of the part bed (Tb) not only has beneficial effects on PPA stability and recyclability of the PPA material, but also reduces the energy consumption during the printing process.

Comparative example E12c however demonstrates that if both the part bed temperature (Tb) and the processing temperature (Tp) are reduced to 190° C., the currently sintering layer instantly begins to crystallize and curl. This causes print failure and an inability to continue printing.

1-15. (canceled)

16. An additive manufacturing process for making a three-dimensional (3D) object, comprising:
a) applying successive layers of a powdered polymer material (M) at a part bed of a SLS printer, the material (M) having a d₅₀-value ranging from 20 to 100 μm, as measured by laser scattering in isopropanol, and comprising at least one semi-crystalline polymer or copolymer (P),
b) heating the layer of powdered polymer material (M) to be printed at a processing temperature (Tp), and selectively sintering each layer prior to deposition of the subsequent layer,
c) keeping the printed part and unsintered material (M′) at a part bed temperature (Tb) until the 3D object is completed,
wherein the process and material (M) are such that at least inequalities (1) to (4) are met:
Tm≥230° C. (1)
Tb<Tp (2)
Tm−40° C.<Tp<Tm (3)
Tg<Tb<Tm−40° C. (4)
wherein Tm (° C.) and Tg (° C.) are respectively the melting temperature and the glass transition temperature of P, as measured by differential scanning calorimetry (DSC) at 20° C./min, according to ASTM D3418.

17. The process of claim 16, wherein the process and material (M) are such that at least one of the inequalities (4) and (3) are as follows:
Tm−40° C.<Tp<Tm−5° C. (3)
Tg<Tb<Tm−50° C. (4).

18. The process of claim 16, wherein the powdered polymer material (M) is preheated in a feed bed of the SLS printer to a feed bed temperature (Tf) which is such that the inequality (7) is met:
Tf<Tp (7).

19. The process of claim 16, wherein the SLS printer is equipped with a part plate which is lowered by one layer thickness of material (M) after each selective sintering occurrence.

20. The process of claim 16, wherein each layer comprises a thickness of between 10 and 800 μm.

21. The process of claim 16, wherein P is selected from the group consisting of a poly(aryl ether ketone) (PAEK), a polyphenylene sulfide (PPS), a semi-aromatic, semi-crystalline polyimide (PI), a polyamide (PA) or a polyphthalamide (PPA), a semi-aromatic polyester and an aromatic polyester (PE).

22. The process of claim 16, wherein the powdered polymer material (M) further comprises 0.01 to 10 wt. % of a flow agent.

23. The process of claim 16, wherein the powdered polymer material (M) further comprises 0.1 to 50 wt. % of a filler selected from the group consisting of calcium carbonate, magnesium carbonate, glass fibers, glass spheres, graphite, carbon black, carbon fibers, carbon nanofibers, graphene, graphene oxide, fullerenes, talc, wollastonite, mica, alumina, silica, titanium dioxide, kaolin, silicon carbide, zirconium tungstate, boron nitride and combinations thereof.

24. The process of claim 16, wherein the powdered polymer material (M) comprises recycled material (M′).

25. The process of claim 16, wherein step b) comprises selective sintering by means of an electromagnetic radiation of the powder.

26. The process of claim 16, comprising a step d) consisting in recovering the unsintered material (M′).

27. A three-dimensional (3D) object obtainable by laser sintering process of claim 16.

28. Recycled powder material (M′), obtainable from an additive manufacturing process for making a three-dimensional (3D) object, the additive manufacturing process comprising:
a) applying successive layers of a powdered polymer material (M) at a part bed of a SLS printer, the material (M) having a d₅₀-value ranging from 20 to 100 μm, as measured by laser scattering in isopropanol, and comprising at least one semi-crystalline polymer or copolymer (P),
b) heating the layer of powdered polymer material (M) to be printed at a processing temperature (Tp), and selectively sintering each layer prior to deposition of the subsequent layer,
c) keeping the printed part and unsintered material (M′) at a part bed temperature (Tb) until the 3D object is completed, and
d) recovering the unsintered material (M′)
wherein the process and material (M) are such that at least inequalities (1) to (4) are met:
Tm≥230° C. (1)
Tb<Tp (2)
Tm−40° C.<Tp<Tm (3)
Tg<Tb<Tm−40° C. (4)
wherein Tm (° C.) and Tg (° C.) are respectively the melting temperature and the glass transition temperature of P, as measured by differential scanning calorimetry (DSC) at 20° C./min, according to ASTM D3418.

29. The recycled powder material (M′) of claim 26, wherein the recycled powdered material (M′) has:
a ΔMFI≤90%,
wherein:
ΔMFI=100×|(MFIₜ₀−MFIₜ₁)/MFIₜ₀|

wherein:
MFI is the Melt Flow Index as measured by ASTM D-1238,
MFIₜ₀ is the MFI of the powder before printing,
MFIₜ₁ is the MFI of the unsintered powder after printing, and/or
a ΔIV≤50%,
wherein:
ΔIV=100×|(IVₜ₀−IVₜ₁)/IVₜ₀|

wherein:
IV is the Inherent Viscosity as measured by ASTM D-5336,
IVₜ₀ is the IV of the powder before printing,
IVₜ₁ is the IV of the unsintered powder after printing.

30. Blend of powder materials for 3D printing, comprising the recycled powder material (M′) of claim 13 or 14.
